(19) United States
(12) Patent Application Publication
(10) Pub. No.: US 2016/0295019 A1
(43) Pub. Date: Oct. 6, 2016

(54) SYSTEM AND METHOD TO SELECT A RESOURCE IN AN ENTERPRISE

(71) Applicant: Avaya Inc., Santa Clara, CA (US)

(72) Inventors: Neil O'Connor, Galway (IE); Tony McCormack, Galway (IE); Dawid Nowak, Dublin (IE)

(21) Appl. No.: 14/674,236

(22) Filed: Mar. 31, 2015

(51) Int. Cl. H04M 3/523; G06Q 10/06; H04M 3/51

(52) U.S. Cl. CPC H04M 3/5233; H04M 3/5175; G06Q 10/06393

(57) ABSTRACT

A predictive system for resource allocation in an enterprise is disclosed. The predictive system includes a database comprising one or more performance indicators for a plurality of resources, wherein the one or more performance indicators are associated with one or more work stages related to at least one communication session in the enterprise. The system further includes a monitoring module to monitor one or more parameters associated with the at least one communication session. The system further includes a determination module to generate at least one performance score for each of the plurality of resources based on the one or more monitored parameters and the one or more performance indicators. The system further includes a selection module to select the at least one resource from the plurality of resources based on the at least one generated performance score associated with the at least one selected resource.

### BACKGROUND

1. Field

Embodiments of the present invention generally relate to a system and method to manage communication sessions in an enterprise and particularly to a system and method to select suitable resources to manage communication sessions in an enterprise.

2. Description of Related Art

Contact centers are employed by many enterprises to service, inbound and outbound contacts or customers. A primary objective of contact center management is to ultimately maximize contact center performance and profitability. An ongoing challenge in contact center administration is monitoring and optimizing contact center efficiency usage of its available resources. The contact center efficiency is generally measured by metrics such as Service Level Agreement (‘SLA’), Customer Satisfaction (‘CSAT’), and match rate. Contact center resources may include, agents, communication assets (e.g., number of voice trunks, number and bandwidth of video trunks, etc.), computing resources (e.g., a speed, a queue length, a storage space, etc.), and so forth.

Service level is one measurement of the contact center efficiency. Service level is typically determined by dividing the number of contacts accepted within a specified period by the number accepted plus number that were not accepted, but completed in some other way (e.g., abandoned, given busy, canceled, flowed out). Service level definitions may vary from one enterprise to another.

Match rate is another indicator used in measuring the contact center efficiency. Match rate is usually determined by dividing the number of contacts accepted by a primary skill level agent within a period of time by the number of contacts accepted by any agent in a queue over the same period. An agent with a primary skill level is one who typically may handle contacts of a certain nature more effectively and/or efficiently as compared to an agent of lesser skill level. There are other contact center agents who may not be as proficient as the primary skill level agent, and those agents are identified either as skill level agents or backup skill level agents. As can be appreciated, contacts received by a primary skill level agent are typically handled more quickly and accurately or effectively (e.g., higher revenue attained) than a contact received by a secondary or even backup skill level agent. Thus, it is an objective of most contact centers to optimize match rate along with the service level.

In addition to service level and match rate performance measures, contact centers use other Key Performance Indicators (‘KPIs’), such as revenue, estimated, actual, or predicted wait time, average speed of answer, throughput, resource utilization, resource performance, resource responsiveness and the like, to calculate performance relative to their Service Level Agreements (‘SLAB’). Operational efficiency is achieved when the KPIs are managed near, but not above, SLA threshold levels.

Throughput is a measure of the number of contacts, contact requests or communication sessions that may be processed in a given amount of time. Resource utilization is a measure of how efficiently the resources' time is being used. Customer service level is a measure of the time customers spend waiting for their work to be handled. Company contact center customers wish to provide service to as many requests as possible in a given amount of time, using the least number of resources to do so, and minimizing the wait time for their customers that may increase the Service Level Agreement (‘SLA’) of the contact center. Further, the contact center may also have to maintain the Customer Satisfaction (‘CSAT’) metrics in order to maintain the KPIs of the contact center. For this purpose, resources may have to maintain the quality of services provided to the customers through multimedia (e.g., voice contacts, video contacts, emails, etc.).

Generally, when a communication session arrives at the contact center or an outbound communication session needs to be established, a suitable resource of the contact center is selected. A suitable resource can be a resource who can handle a communication session efficiently by providing assistance and/or customer services to a customer. Traditionally, the suitable resource can be selected based on proficiency or skill level of resources. Some of the resources may be gold rated or highly skilled, i.e., they can be highly experienced and are highly proficient in providing services or assistance to customers. Some of the resources are silver rated or less skilled, i.e., they can have less experience or trainees that are less proficient in providing services or assistance to customers of the contact center. Therefore, a highly skilled resource can be selected at the time when an inbound or outbound communication is to be started to improve the KPIs of the contact center. However, in conventional systems, proficiency parameter is used to determine how good a resource can be at work in a given skill and/or service, which is a unidirectional parameter. Also, conventional systems do not take into account other parameters in order to select a proficient resource for a communication session.

There is thus a need for a system and method to manage selection of resources to manage communication sessions in an enterprise in a more efficient manner.

### SUMMARY

Embodiments in accordance with the present invention provide a predictive system for resource allocation in an enterprise. The predictive system includes a database comprising one or more performance indicators for a plurality of resources, wherein the one or more performance indicators are associated with one or more work stages related to at least one communication session in the enterprise. The system further includes a monitoring module to monitor one or more parameters associated with the at least one communication session. The system further includes a determination module to generate at least one performance score for each of the plurality of resources based on the one or more monitored parameters and the one or more performance indicators. The system further includes a selection module to select the at least one resource from the plurality of resources based on the at least one generated performance score associated with the at least one selected resource.

Embodiments in accordance with the present invention further provide a computer-implemented method for resource allocation in an enterprise. The method includes storing one or more performance indicators for a plurality of resources in at least one database, wherein the one or more performance indicators are associated with one or more work stages related to at least one communication session in the enterprise; monitoring one or more parameters associated with the at least one communication session; generating at least one performance score for each of the plurality of resources based on the one or more monitored parameters and the one or more performance indicators; selecting the at least one resource from the plurality of resources based on the at least one generated performance score associated with the at least one selected resource; routing the at least one communication session to the at least one selected resource; and updating the performance score of the selected resource in the at least one database.

Embodiments in accordance with the present invention further provide a computer-implemented method to manage at least one communication session in an enterprise. The method includes storing one or more performance indicators for a plurality of resources in at least one database, wherein the one or more performance indicators are associated with one or more work stages related to at least one communication session in the enterprise; monitoring one or more parameters associated with the at least one communication session; generating at least one performance score for each of the plurality of resources based on the one or more monitored parameters and the one or more performance indicators; selecting the at least one resource from the plurality of resources based on the at least one generated performance score associated with the at least one selected resource; validating the at least one performance score associated with the at least one selected score based on handling of the at least one communication session by the at least one selected resource; and updating the validated performance score in the at least one database, wherein the at least one database is updated based on the validation of the at least one performance score.

Embodiments of the present invention may provide a number of advantages depending on its particular configuration. First, embodiments of the present application provide a system and a method to select a resource to manage a communication session. Next, embodiments of the present application may be used to fine tune actual preparation and execution times and further optimizes the resource selection decision towards an overall business goal.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1A illustrates a block diagram depicting a contact center, according to an embodiment of the present invention;

FIG. 1B illustrates a high level hardware abstraction of a block diagram of a server, according to an embodiment of the present invention;

FIG. 2 illustrates a functional block diagram of the server that may be used in the contact center, according to an embodiment of the present invention;

FIG. 3 depicts a flowchart of a method for resource allocation in the contact center, according to an embodiment of the present invention; and

FIG. 4 depicts a flowchart of a method for resource allocating in the contact center, according to another embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

Embodiments of the present invention will be illustrated below in conjunction with an exemplary communication system, e.g., the Avaya Aura® system. Although well suited for use with, e.g., a system having an Automatic Call Distribution (ACD) or other similar contact processing switch, embodiments of the present invention are not limited to any particular type of communication system switch or configuration of system elements. Those skilled in the art will recognize the disclosed techniques may be used in any communication application in which it is desirable to provide improved contact processing.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read.

The terms “customer” and “contact” may be used interchangeably in certain context of this disclosure of the present invention when referring to one or more persons or entities contacting a contact center, usually to reach an IVR system and/or one or more agents for assistance. In another context contemplated by the present invention, a “customer” may have more than one contact with the contact center at, or nearly at, the same time. For example, a customer may communicate with a contact center by way of telephone and by way of a chat, thus counting as one customer but two contacts.

The term “resource” may be used interchangeably in certain context with “agent” within this disclosure of the present invention when referring to one or more persons or entities servicing a contact in a contact center or a knowledge resource within an enterprise servicing back office transactions. In an embodiment of the present invention, the resource may be, but is not restricted to, an agent, an available agent, a reserve agent, a trainee agent, a Subject Matter Expert (SME), a supervisor, and so forth.

A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, embodiments may include a tangible storage medium or distribution medium and prior art-recognized equivalents and successor media, in which the software embodiments of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the present invention is described in terms of exemplary embodiments, it should be appreciated those individual aspects of the present invention can be separately claimed.

The term “switch” or “server” as used herein should be understood to include a Private Branch Exchange (PBX), an ACD, an enterprise switch, or other type of communications system switch or server, as well as other types of processor-based communication control devices such as media servers, computers, adjuncts, etc.

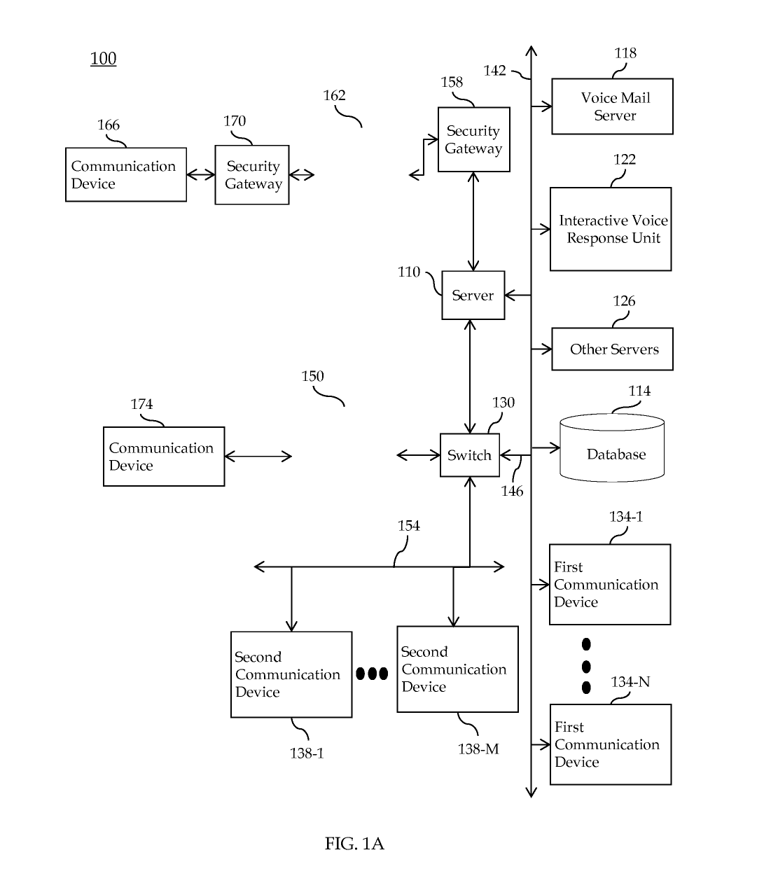

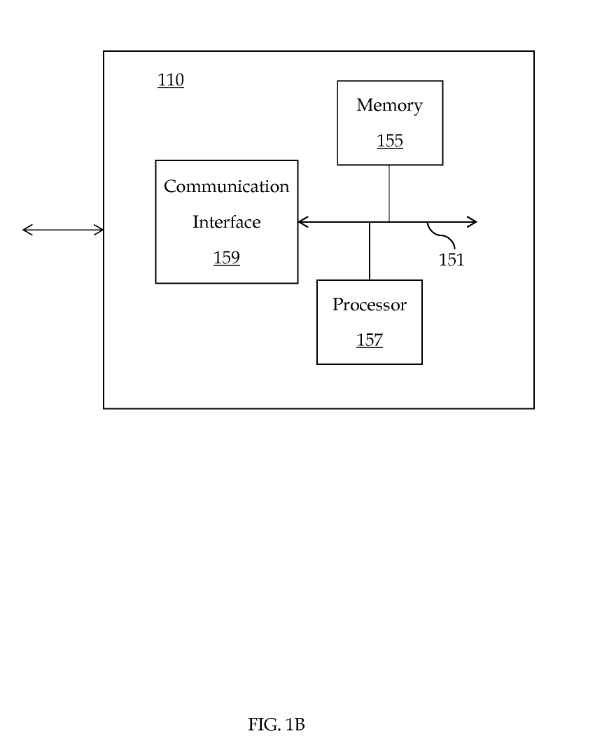

FIG. 1A shows an illustrative embodiment of the present invention. A contact center 100 comprises a server 110, a set of data stores or databases 114 containing contact or customer related information, resource related information and other information that may enhance the value and efficiency of the contact processing, and a plurality of servers, namely a voice mail server 118, an Interactive Voice Response unit (e.g., IVR) 122, and other servers 126, a switch 130, a plurality of working resources operating packet-switched (first) communication devices 134-1-N (such as computer work stations, or personal computers), and/or circuit-switched (second) communication devices 138-1-M, all interconnected by a Local Area Network (LAN) 142, (or Wide Area Network (WAN)). In another embodiment of the present invention, the customer and resource related information may be replicated over multiple databases.

The servers may be connected via optional communication lines 146 to the switch 130. As will be appreciated, the other servers 126 may also include a scanner (which is normally not connected to the switch 130 or Web Server), VoIP software, video call software, voice messaging software, an IP voice server, a fax server, a web server, an email server, and the like. The switch 130 is connected via a plurality of trunks to a circuit-switched network 150 (e.g., Public Switch Telephone Network (PSTN)) and via link(s) 154 to the second communication devices 138-1-M. A security gateway 158 is positioned between the server 110 and a packet-switched network 162 to process communications passing between the server 110 and the packet-switched network 162. In an embodiment of the present invention, the security gateway 158 (as shown in FIG. 1A) may be Avaya Inc.'s, G700 Media Gateway™ and may be implemented as hardware such as via an adjunct processor (as shown) or as a chip in the server 110.

The switch 130 and/or server 110 may be any architecture to direct contacts to one or more communication devices. In some embodiments of the present invention, the switch 130 may perform load-balancing functions by allocating incoming or outgoing contacts among a plurality of logically and/or geographically distinct contact centers. Illustratively, the switch 130 and/or server 110 may be a modified form of the subscriber-premises equipment sold by Avaya Inc. under the names Definity™ Private-Branch Exchange (PBX) based ACD system, MultiVantage™ PBX, Communication Manager™, S8300™ media server and any other media servers, SIP Enabled Services™, Intelligent Presence Server™, and/or Avaya Interaction Center™, and any other products or solutions offered by Avaya, or another company. Typically, the switch 130 and/or server 110 is a stored-program-controlled system that conventionally includes interfaces to external communication links, a communications switching fabric, service circuits (e.g., tone generators, announcement circuits, etc.), memory to store control programs and data, and a processor (i.e., a computer) to execute the stored control programs to control the interfaces and the fabric and to provide ACD functionality. Other types of known switches and servers are well known in the art and therefore not described in detail herein.

The first communication devices 134-1-N are packet-switched and may include, for example, IP hardphones such as the Avaya Inc.'s, 4600 Series IP Phones™, IP softphones such as Avaya Inc.'s, IP Softphone™, Personal Digital Assistants (PDAs), Personal Computers (PCs), laptops, packet-based H.320 video phones and conferencing units, packet-based voice messaging and response units, packet-based traditional computer telephony adjuncts, peer-to-peer based communication devices, and any other communication device.

The second communication devices 138-1-M are circuit-switched devices. Each of the second communication devices 138-1-M corresponds to one of a set of internal extensions Ext-1-M, respectively. The second communication devices 138-1-M may include, for example, wired and wireless telephones, PDAs, H.320 videophones and conferencing units, voice messaging and response units, traditional computer telephony adjuncts, and any other communication devices.

It should be noted that embodiments of the present invention do not require any particular type of information transport medium between switch, or server and first and second communication devices, i.e., embodiments of the present invention may be implemented with any desired type of transport medium as well as combinations of different types of transport channels.

The packet-switched network 162 may be any data and/or distributed processing network, such as the Internet. The packet-switched network 162 typically includes proxies (not shown), registrars (not shown), and routers (not shown) to manage packet flows.

The packet-switched network 162 as shown in FIG. 1A is in communication with a first communication device 166 via a security gateway 170, and the circuit-switched network 150 with an external second communication device 174.

In one configuration, the server 110, the packet-switched network 162, and the first communication devices 134-1-N are Session Initiation Protocol (SIP) compatible and may include interfaces for various other protocols such as the Lightweight Directory Access Protocol (LDAP), H.248, H.323, Simple Mail Transfer Protocol (SMTP), Internet Message Access Protocol 4 (IMAP4), Integrated Services Digital Network (ISDN), E1/T1, and analog line or trunk.

It should be emphasized the configuration of the switch 130, the server 110, customer communication devices, and other elements as shown in FIG. 1A is for purposes of illustration only and should not be construed as limiting embodiments of the present invention to any particular arrangement of elements.

Further, the server 110 is notified via the LAN 142 of an incoming contact by the communications component (e.g., switch 130, a fax server, an email server, a web server, and/or other servers) receiving the incoming contact as shown in FIG. 1A. The incoming contact is held by the receiving telecommunications component until the server 110 forwards instructions to the component to forward or route the contact to a specific contact center resource, such as the IVR unit 122, the voice mail server 118, and/or first or second telecommunication device 134-1-N, 138-1-M associated with a selected resource.

FIG. 1B illustrates at a relatively high-level hardware abstraction of a block diagram of a server such as the server 110, in accordance with an embodiment of the present invention. The server 110 may include an internal communication interface 151 that interconnects a processor 157, a memory 155 and a communication interface circuit 159. The communication interface circuit 159 may include a receiver and transmitter (not shown) to communicate with other elements of the contact center 100 such as the switch 130, the security gateway 158, the LAN 142, and so forth. By use of programming code and data stored in the memory 155, the processor 157 may be programmed to carry out various functions of the server 110.

Although embodiments are discussed with reference to client-server architecture, it is to be understood the principles of embodiments of the present invention apply to other network architectures. For example, embodiments of the present invention apply to peer-to-peer networks, such as those envisioned by the Session Initiation Protocol (SIP). In the client-server model or paradigm, network services and the programs used by end customers to access the services are described. The client side provides a customer with an interface to request services from the network, and the server side is responsible for accepting customer requests for services and providing the services transparent to the customer. By contrast in the peer-to-peer model or paradigm, each networked host runs both the client and server parts of an application program. Additionally, embodiments of the present invention do not require the presence of packet- or circuit-switched networks.

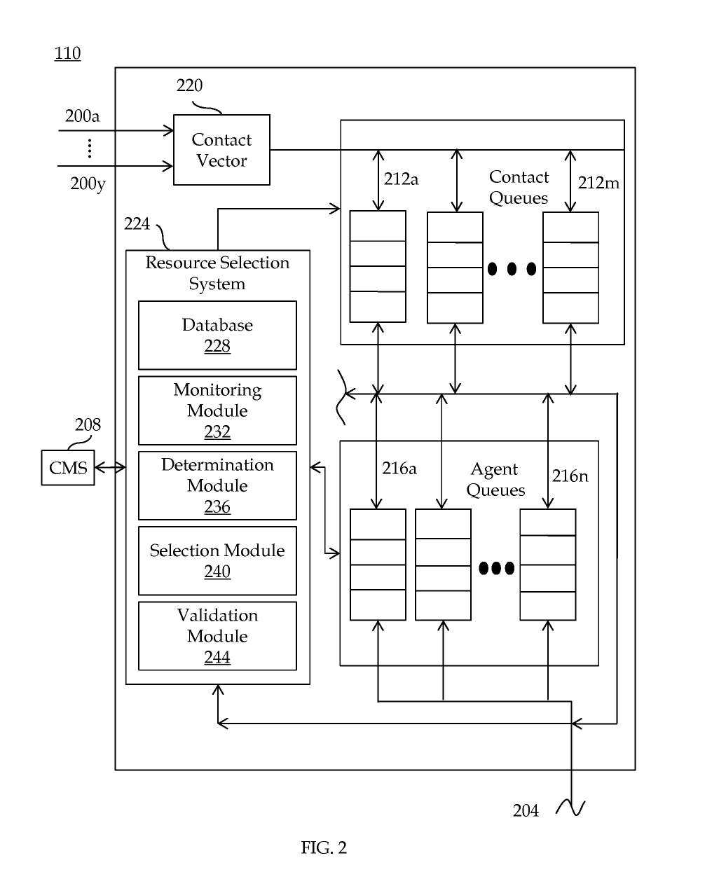

Referring to FIG. 2, one possible configuration of the server 110 is depicted at a relatively high level of functional abstraction, according to an embodiment of the present invention. The server 110 is in communication with a plurality of contact or customer communication lines 200a-y (which may be one or more trunks, phone lines, etc.) and an agent communication line 204 (which may be a voice-and-data transmission line such as the LAN 142 and/or a circuit switched voice line). The server 110 may include Avaya Inc.'s Operational Analyst™ (OA) with On-Line Analytical Processing (OLAP) technology or a Call Management System (CMS) 208 that gathers contact records. OA and CMS will hereinafter be referred to jointly as CMS 208.

As shown in FIG. 2, among the data stored in the server 110 is a set of contact queues 212a-n and a separate set of agent queues 216a-n. Each contact queue 212a-n corresponds to a different set of agent queues, as does each agent queue 216a-n. Conventionally, contacts are prioritized and either are queued in individual ones of the contact queues 212a-n in their order of priority or are queued in different ones of a plurality of contact queues 212a-n that correspond to a different priority. Likewise, each agent's queues are prioritized according to his or her level of expertise or skill in that queue, and agents are queued in either individual ones of agent queues 216a-n in their order of expertise level, or in different ones of a plurality of agent queues 216a-n that correspond to a queue and each one of which corresponds to a different expertise or skill level. In an embodiment of the present invention, the agent queue 216a-n may include a set of reserve resources queue in the contact center 100. In another embodiment of the present invention, the agent queue 216a-n may include a set of available resources in the contact center 100.

According to an embodiment of the present invention, included among the control programs in the server 110 is a contact vector 220. Contacts or communication sessions incoming to the contact center 100 are assigned by the contact vector 220 to different contact queues 212a-n based upon a number of predetermined criteria, including a customer's identity, customer needs, contact center needs, current contact center queue lengths, a customer value, an agent skill that is required for proper handling of the contact, or a combination thereof. Resources available to handle the contacts are assigned to the agent queues 216a-n based upon the skills that they possess, in an embodiment of the present invention. A resource may have multiple skills, and hence may be assigned to multiple agent queues 216a-n simultaneously, according to an embodiment of the present invention. In another embodiment of the present invention, the resource may be assigned to a specific agent queue 216a-n based on a specific skill. Furthermore, a resource may have different levels of skill expertise (e.g., skill levels 1-N in one configuration or merely primary skill levels and secondary skill levels in another configuration), and hence may be assigned to different agent queues 216a-n at different expertise levels.

In one configuration, the contact center 100 is operated by a contract operator (e.g., a supervisor or a manager of the contact center 100), and each of the contact queues 212a-n, and possibly each of the agent queues 216a-n, corresponds to a different client such as, but not limited to, a customer. Each client may have a separate Service Level Agreement (‘SLA’) or other type of performance measurement agreement with the contract operator regarding performance expectations, goals, requirements or specifications for the client's respective queue(s).

Further, embodiments in accordance with the present invention may include, among the programs executing on the server 110, a predictive system 224. The predictive system 224 is stored either in the main memory or in a peripheral memory (e.g., disk, CD ROM, etc.) or some other computer-readable medium of the contact center 100. Further, the predictive system 224 monitors the occupants of the contact and agent queues 212a-n and 216a-n, respectively, and contact center objectives, rules, and policies and select resources to service contacts.

The predictive system 224 distributes and connects these contacts to communication devices of available resources. When the predictive system 224 forwards a contact (or first communication session) to a resource, the predictive system 224 also forwards customer-related information from the database 114 to the resource's desktop or computer work station to preview and/or to view (such as by a pop-up display) to enable the resource to provide better services to the customer. Depending on the contact center configuration, the predictive system 224 may reallocate the contact to the resources of the contact center 100. The resources may then process the contacts or communication sessions sent to them by the predictive system 224.

In an embodiment of the present invention, the resource and their associated data are maintained and updated in the database 114 of the contact center 100. Upon the completion of handling a contact, a generator (not shown) collects selected metrics for the contact. These metrics may include skills involved in servicing the contact, an identifier of a servicing resource, contact duration, a transaction or contact type (e.g., sale, information request, complaint, etc.), time-of-day, result of the contact (e.g., type of sale, number of units sold, an average revenue generated, etc.), and so forth. The metrics along with other statistics is typically gathered by the CMS 208.

According to an embodiment of the present invention, the predictive system 224 includes certain modules, such as, but not restricted to, a database 228, a monitoring module 232, a determination module 236, a selection module 240, and a validation module 244. In some embodiments of the present invention, one or more of the database 228, the monitoring module 232, the determination module 236, the selection module 240, and the validation module 244 may be implemented by one or more software processes running on the server 110. The server 110 may implement one or more software processes by use of the processor 157 being suitably programmed by use of software instructions stored in the memory 155 coupled to the processor 157.

The database 228 may store performance indicators for a plurality of resources of the contact center 100, according to an embodiment of the present invention. The performance indicators may be associated with work stages related to a communication session, according to an embodiment of the present invention. The performance indicators may include, but are not restricted to, time taken by each of the resources in the work stages such as a preparation stage, an execution stage, a post-call stage, a score associated with each of the resources, or a combination thereof. A preparation time is the time required and/or taken by a resource to prepare for a communication session to provide assistance or services to a customer of the communication session. The preparation for the communication session may include, but is not restricted to, selecting a script, controlling pitch, searching for a product or service associated with a communication session. For example, a customer may select ‘health policy’ in an IVR menu then a resource may search for updated information about the ‘health policy’, and the like. In an embodiment of the present invention, resources of the contact center 100 may anticipate preparation time required to service a communication session. In another embodiment of the present invention, the predictive system 224 may anticipate preparation time that may be provided to resources of the contact center 100. For example, for an outbound communication session corresponding to a life policy, it may be anticipated that a resource may need five minutes of preparation time before commencing the communication session.

Further, the execution time may be time of conversation between a resource and a customer. In above exemplary scenario, the resource may complete the communication session within two minutes as the resource may be well prepared for the communication session based on the preparation. In another exemplary scenario, an execution time for an incoming communication session may not be anticipated as a resource may be unaware of time required to process the incoming communication session. Furthermore, the post-call time may be time required and/or taken by a resource to complete post-call work that may include, but is not restricted to, fill a feedback form, submit documents associated with a communication session, provide additional information to customers through text communication session, and the like. In the above exemplary scenario, the resource may complete paper work of the life insurance policy purchased by the customer within ten minutes. In another exemplary scenario, when three resources are available, then the preparation time, execution time, and the post-call time may be stored for all the three resources, such as preparation time for an agent ‘A’ may be ‘2 minutes’, for an agent ‘B’ may be ‘4 minutes’ and for an agent ‘C’ may be ‘7 minutes’, the execution time for the agent ‘A’ may be ‘4 minutes’, for the agent ‘B’ may be ‘3 minutes’ and for the agent ‘C’ may be ‘3 minutes’, and the post-call time for the agent ‘A’ may be ‘5 minutes’, for the agent ‘B’ may be ‘6 minutes’ and for the agent ‘C’ may be ‘4 minutes’. Further, each of the performance indicators may be associated with a data value, according to an embodiment of the present invention. In an embodiment of the present invention, the data values of the performance indicators may be determined based on quality and/or quantity of work, time management, creativity in handling customers, and the like.

The monitoring module 232 may monitor parameters associated with a communication session, according to an embodiment of the present invention. The monitoring module 232 may monitor parameters associated with the communication session, in accordance with an embodiment of the present invention. In an embodiment of the present invention, the monitoring module 232 may monitor a type of the communication session. The type of the communications session may include, but is not restricted to, a voice communication session, a video communication session, a Short Message Service (SMS), a web chat communication session, an Instant Messaging (IM) communication session, an email communication session, an Interactive Voice Response (IVR) communication session, a Voice over Internet Protocol (VoIP) communication session, and so forth. In an exemplary scenario, the communication session may be initiated by a customer of the contact center 100. In another exemplary scenario, the communication session may be initiated by a resource of the contact center 100. Further, the monitoring module 232 may monitor static details of the communication session by monitoring inputs selected by the customer in an IVR menu of the contact center 100, according to an embodiment of the present invention.

The monitoring module 232 may further monitor details of a customer associated with the communication session, according to an embodiment of the present invention. The details of the customer may include, but are not restricted to, personal information (for example, a name, a social networking username, etc.), contact information (for example, a telephone number, an email address, etc.), educational background, business contacts, education and work histories, likes, hobbies, favorite sport teams, frequency of conversations with a resource, a history of queries, a customer identification, communication history with the contact center 100, a type of customer, and so forth. In an embodiment of the present invention, the monitoring module 232 may extract the details of the customer from various social networking websites. In another embodiment of the present invention, the monitoring module 232 may extract details of the customer from a database such as the database 114, or the database 228 of the contact center 100. The type of the customer may be, but is not restricted to, a high priority customer, a medium priority customer, and/or a low priority customer. A high priority customer may have higher revenue products and/or services provided by the contact center 100. A medium priority customer may have medium revenue products and/or services provided by the contact center 100. Further, a low priority customer may be a potential customer or a customer having low revenue products and/or services provided by the contact center 100.

Further, the monitoring module 232 may monitor details of resources of the contact center 100, according to an embodiment of the present invention. In an embodiment of the present invention, the resources may be available resources that may handle a communication session as soon as it arrives, or may initiate a communication session in the contact center 100. In another embodiment of the present invention, resource may be, but are not restricted to, reserve agents, trainee agents, Subject Matter Experts (SMEs), supervisors, and so forth.

The monitoring module 232 may further monitor other details of resources, which may include, but is not restricted to, a name, a phone number, an extension number, resource identification (ID), social networking usernames, a resource's interests, hobbies, hometowns, favorite sport teams and TV shows, cultural background, education and work histories, skill set, technical training or experience in supporting a particular industry, company, or contact, and so forth. As used herein, the term ‘skill set’ refers to a set of resource data that may be used by the contact center 100 to characterize a resource. Such resource data may include, but not restricted to, biographical resource data, demographic resource data, external or internal behavioral resource data, to name a few. The behavioral data may include the resource's history with respect to the contact center 100 and/or any other entity or social media channel. However, the resource data is not limited in this regard and may include any other type of resource data used by the contact center 100 to characterize or classify the resources of the contact center 100. Further, the resource data may include any other resource data collected from one or more sources external to the contact center 100. Additionally, a resource profile having the details of a resource may be raw resource data or processed resource data. That is, the resource data may be analyzed to characterize the resource and thereafter used to provide customized or personalized services to the customer. For example, a resource profile may be a set of values associated with a resource and a set of characteristics, where the values may be selected based on the resource data obtained. However, the present application is not limited in this regard, and any other methods to evaluate resource data to provide services may be used without limitation.

The monitoring module 232 may further determine context of the communication session, according to an embodiment of the present invention. The context of the communication session may include, but is not restricted to, a product inquiry support, a sales support, a health insurance policy support, a life insurance policy, a financial transaction support, and the like. In an exemplary scenario, a customer may provide inputs in an IVR menu of the contact center 100 for a ‘health insurance policy’, then it may be determined that context of the communication session is a product inquiry support for a health insurance policy. The monitoring module 232 may further monitor performance history of the resources of the contact center 100, in accordance with an embodiment of the present invention. In an exemplary scenario, an average preparation time, an average execution time, an average post-call time, or a combination thereof, associated with the resources may also be monitored and extracted from the database 114 of the contact center 100.

Furthermore, the monitoring module 232 may extract keywords from the monitored communication session, according to an embodiment of the present invention. In an exemplary scenario, a customer may inquire about ‘car service’ then the monitoring module 232 may extract keywords such as ‘inquiry’, ‘car’ and ‘service’ from the communication session.

In an embodiment of the present invention, the monitoring module 232 may monitor the parameters associated with a communication session and a plurality of resources in a real-time environment. The parameter associated with the communication session may include, but is not restricted to, a type of a communication session, context of a communication session, static details of a communication session, details of a customer, details of a resource, or a combination thereof, in accordance with an embodiment of the present invention. However, embodiments of the present invention are not limited in this regard and may include other parameters associated with the communication session and a plurality of resources that may be used without limitation.

The determination module 236 may allocate the anticipated preparation time to resources to prepare for the communication session, in an embodiment of the present invention. In an exemplary scenario, a resource may prepare for three communication sessions and may then execute them one after another. In an embodiment of the present invention, when the preparation time is going to be over, an indication may be displayed on the resources' desktop. Further, the determination module 236 may determine the data value of each of the performance indicators associated with the plurality of resources of the contact center 100, according to an embodiment of the present invention. In an embodiment of the present invention, the data value may be a numeric value, for example, two, five, eight, and the like, a percentage value, for example, 54%, 60%, 120%, and the like. Further, the determination module 236 may generate a performance score for each of the plurality of resources, according to an embodiment of the present invention. In an embodiment of the present invention, the determination module 236 may generate a performance score based on the determined data value. In an embodiment of the present invention, the generated performance score may be a weighted combination of the data values associated with the performance indicators. In an exemplary scenario, an agent ‘A’ may take ‘4 minutes’ for the execution of the communication session and takes ‘10 minutes’ for the post-call time as the agent ‘A’ may be slow at navigating the CMS 208 and then may go to second floor to submit documents, whereas another agent ‘B’ may take ‘5 minutes’ for the execution of the communication session and takes ‘4 minutes’ for the post-call time, then a performance score for the agent ‘A’ may be computed as five, and performance score for the agent ‘B’ may be computed as two, as the overall time of the agent ‘B’ is less than the time of the agent ‘A’.

In another example, suppose that Agent “A” takes on average “N1” minutes to complete phase 1 of a customer contact (e.g., pre-call preparation), “N2” minutes to complete phase 2 (e.g., conducting the call itself), and “N3” minutes to complete phase 3 (e.g., post-call time). Agent A may have a nominal weighting vector of, e.g., [1.0, 1.0, 1.0], such that each element of the weighting vector is used to weight the number of minutes that Agent A takes to complete the corresponding phase of the call. Agent B may have a different set of average number of minutes to complete each phase of a call, and in general may have a different weighting vector. The when contemplating whether to select Agent A or Agent B for the next call, the average number of minutes for each phase of a call for both agents may be weighted by the agent's weighting vector.

Each agent's weighting vector may be a function of characteristics of calls that the agent has handled. Characteristics may include the identity of the caller or the caller's organization, subject matter of the call, difficulty of the call, and so forth. The weighting vector may change on a per-contact basis, based on the exact nature and context around that particular contact and the type of contact (voice, email, etc.). For example, an incoming call pertaining to Mortgage Sales has arrived. Both Agent A and Agent B may be capable of handling such work. The average preparation/execution/post-call times are known for each subject matter and type of contact, and for a Mortgage Sale call the averages may be 5/10/5 minutes, respectively, either individually for an agent or over a set of agents (e.g., over all available agents, over all qualified agents, over all qualified agents who are also available, etc.). These averages may be modified if it is known before assigning the call to an agent that this is a difficult or demanding customer. Further suppose that Agent A is a superstar if given plenty of preparation time, so determination module 236 may assign a weighting vector of [2.0/0.5/0.5] to Agent A if handling this call. Further, suppose that Agent B is an average-performing agent if handling this call, so determination module 236 may assign a weighting vector of [1.0/1.0/1.0] to Agent B if handling this call. In this numeric example, determination module 236 would select Agent A for the Mortgage Sale call, since Agent A's weighted score of 17.5 minutes is less than Agent B's weighted score of 20.0 minutes.

Further suppose that the next contact that needs to be assigned to an agent is a call pertaining to Insurance Sale, for which the average agent work times are different (e.g., 5/5/5 minutes for this subject matter and this customer). The agent weighting vectors will be different as well. Suppose that Agent A is an average performer for this type of call from this customer, and therefore has a weighting vector of [1.0, 1.0, 1.0]. Agent B might be preferred for this work from this customer because of a superior post-call ratio so long as Agent B spends just a tiny bit extra time when speaking to the customer, expressed as a weighting vector of [1.0, 1.1, 0.6]. In this example, Agent B's weighted score of 13.5 minutes is less than Agent A's weighted score of 15.0 minutes, so Agent B would be selected to handle the call.

Note that in the case of real-time contacts such as inbound voice calls, the maximum value of average preparation time may be very low or even zero. Embodiments may operate in the same way with such contacts as it would with white-mail routing, outbound, inbound chat/email or other types of contacts.

Further, the determination module 236 may rank the resources based on their generated performance scores, according to an embodiment of the present invention. In an exemplary scenario, a resource with a highest performance score may be ranked as ‘rank 1’ whereas, a resource with a least performance score may be ranked as ‘rank 20’, if there are 20 available resources in the contact center 100. In another exemplary scenario, a resource with a least performance score may be ranked as ‘rank 1’ whereas, a resource with a highest performance score may be ranked as ‘rank 20’, if there are 20 available resources in the contact center 100. In an embodiment of the present invention, the determination module 236 may rank the plurality of resources based Key Performance Indicators (KPIs) of the contact center 100. The KPIs may include, but are not restricted to, revenue, estimated, actual, or predicted wait time, average speed of answer, throughput, resource utilization, resource performance, resource responsiveness and the like.

The selection module 240 may select a resource to provide assistance and/or services to the customer of the communication session, according to an embodiment of the present invention. The selection module 240 may select a resource based on the ranks of the plurality of resources, according to an embodiment of the present invention. In an exemplary scenario, for an incoming communication session from a gold customer, a proficient resource may be required then a resource having ‘rank 1’ may be selected. In another exemplary scenario, it may be determined that a trainee of a contact center 100 may handle an outbound communication session, then a trainee having ‘rank 10’ may be selected. The selection module 240 may select a resource based on the KPIs of the contact center 100, according to another embodiment of the present invention. In an exemplary scenario, if a communication session from a gold rated customer arrives then a highly skilled resource who may have ‘rank 4’ may be selected as the selected resource may turn outcome of the communication session into a successful outcome that may further increase revenue of the contact center 100.

The selection module 240 may further route the communication session to the selected resource of the contact center 100, according to an embodiment of the present invention. In an embodiment of the present invention, a supervisor of the contact center 100 may manually route the communication session to the selected resource. The selection module 240 may automatically route the communication session to the selected resource of the contact center 100, in accordance with another embodiment of the present invention.

The validation module 244 may validate the performance score of the selected resource based on handling of the communication session by the selected resource, according to an embodiment of the present invention. The validation module 244 may validate the performance score by calculating data values of the performance indicators, for example, preparation time, execution time, post-call time, or a combination thereof time taken by the selected resource, after completing the communication session, according to an embodiment of the present invention. In an exemplary scenario, the selected resource may manually, for example, push a button, indicate that the resource has completed the communication session and its associated post-call work. In another exemplary scenario, the completion of the communication session and its associated post-call work may be automatically detected.

Further, the validation module 244 may combine the data values of the performance indicators to compute an aggregated performance score for the selected resource, according to an embodiment of the present invention. The validation module 244 may then compare the performance score and the aggregated performance score, which is then used to determine whether the resource have completed the communication session within the anticipated time, according to an embodiment of the present invention.

Furthermore, the validation module 244 may update the database 228 based on the validation of the performance score of the selected resource, according to an embodiment of the present invention. In an embodiment of the present invention, the database 228 may be created based on the generated performance scores of the plurality of resources. The database 228 may be updated based on the generated performance scores of the plurality of resources, according to another embodiment of the present invention. The database 228 may be an internal database of the contact center 100, in an embodiment of the present invention. In another embodiment of the present invention, the database 228 may be the database 114 of the contact center 100. The database 228 may be a third-party hosted database, according to yet another embodiment of the present invention

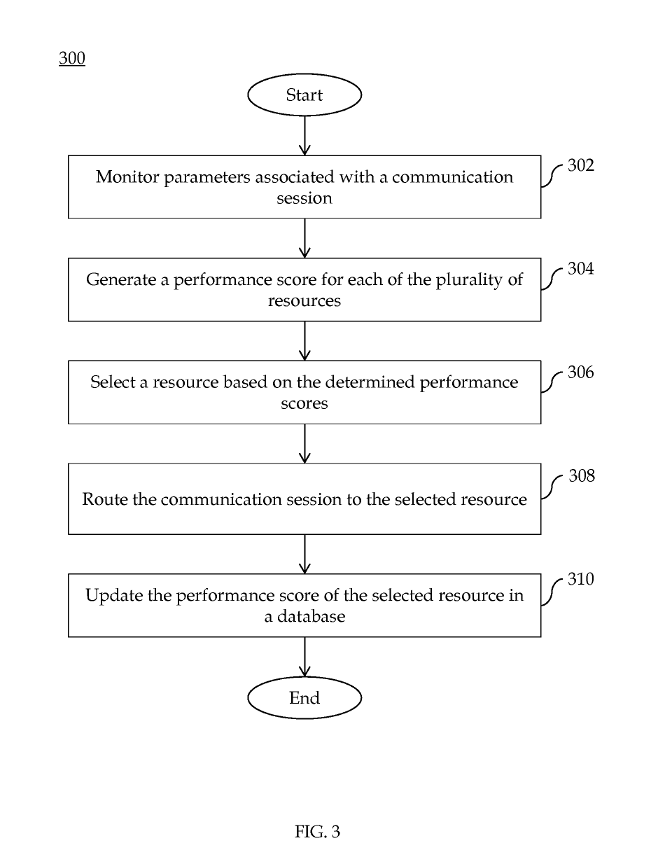

FIG. 3 depicts a flowchart of a method 300 for resource allocation in the contact center 100, according to an embodiment of the present invention

At step 302, the predictive system 224 monitors parameters associated with the communication session and resources of the contact center 100, according to an embodiment of the present invention. In an embodiment of the present invention, the predictive system 224 monitors a type of the communication session such as, but not restricted to, a voice session, a video session, a Short Message Service (SMS), a web chat, an Instant Messaging (IM), an email communication, an Interactive Voice Response (IVR) session, a Voice over Internet Protocol (VoIP) session, and so forth. Further, the predictive system 224 monitors static details of the communication session by monitoring inputs selected by the customer in an IVR menu of the contact center 100, according to an embodiment of the present invention. The predictive system 224 further monitors details of the customer associated with the communication session, which may include, but not restricted to, personal information (for example, a name, a social networking username, etc.), contact information (for example, a telephone number, an email address, etc.), educational background, business contacts, education and work histories, likes, hobbies, favorite sport teams, frequency of conversations with a resource, a history of queries, a customer identification, communication history with the contact center 100, and so forth. Furthermore, the predictive system 224 monitors a type of the customer, according to an embodiment of the present invention. In an exemplary scenario, a customer may be, but not restricted to, a high priority customer, a medium priority customer, and/or a low priority customer.

Further, the predictive system 224 monitors details of resources of the contact center 100, according to an embodiment of the present invention. The details of a resource may include, but not restricted to, a name, a phone number, an extension number, resource identification (ID), social networking usernames, a resource's interests, hobbies, hometowns, favorite sport teams and TV shows, cultural background, education and work histories, skill set, technical training or experience in supporting a particular industry, company, or contact, and so forth.

The predictive system 224 further determines context of the communication session, according to an embodiment of the present invention. The context of the communication session may include, but not restricted to, a product inquiry support, a sales support, a health, or car policy support, a financial transaction support, and so forth. In an embodiment of the present invention, each of the performance indicators may be associated with a data value. Furthermore, the predictive system 224 extracts keywords from the monitored communication session, according to an embodiment of the present invention. In an embodiment of the present invention, the predictive system 224 monitors the parameters in a real-time environment.

At step 304, the predictive system 224 generated a performance score for each of the plurality of resources, according to an embodiment of the present invention. In an embodiment of the present invention, the predictive system 224 generates the performance score for each of the plurality of resources based on the monitored parameters and performance indicators stored in the database 228, according to an embodiment of the present invention.

In an embodiment of the present invention, the generated performance score may be a weighted combination of the data values associated with the performance indicators and the parameters. Further, the predictive system 224 ranks the resources based on their generated performance score, according to an embodiment of the present invention. In an embodiment of the present invention, the predictive system 224 ranks the plurality of resources based Key Performance Indicators (KPIs) of the contact center 100. The KPIs may include, but are not restricted to, revenue, estimated, actual, or predicted wait time, average speed of answer, throughput, resource utilization, resource performance, resource responsiveness and the like.

Further, at step 306, the predictive system 224 selects a resource from the plurality of resources to provide assistance and/or services to the customer of the communication session, according to an embodiment of the present invention. The predictive system 224 selects a resource based on the ranks of the plurality of resources, according to an embodiment of the present invention. In an exemplary scenario, for an incoming communication session from a potential customer, then a trainee may handle the communication session then a resource having ‘rank 7’ may be selected. In another exemplary scenario, it may be determined that a trainee of a contact center 100 may handle an outbound communication session of a medium priority customer, then a trainee having ‘rank 10’ may be selected. The predictive system 224 selects a resource based on the KPIs of the contact center 100, according to another embodiment of the present invention.

Thereafter, at step 308, the predictive system 224 routes the communication session to the selected resource of the contact center 100, according to an embodiment of the present invention. In an embodiment of the present invention, a supervisor of the contact center 100 may manually route the communication session to the selected resource. The predictive system 224 routes automatically route the communication session to the selected resource of the contact center 100, in accordance with another embodiment of the present invention. Next, at step 310, the predictive system 224 may update the performance score of the selected resource in the database 228, or the database 114, according to an embodiment of the present invention.

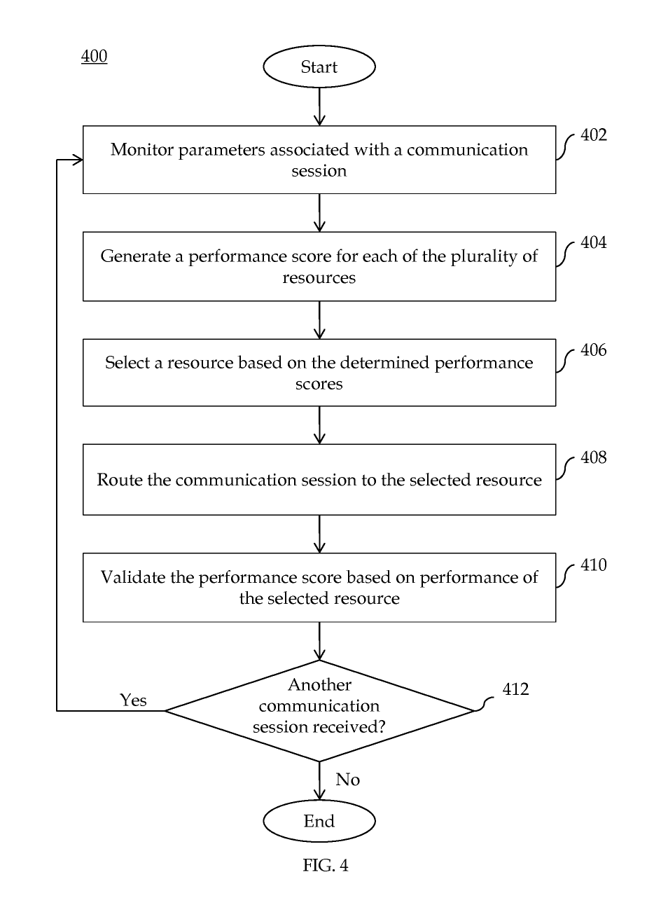

FIG. 4 depicts a flowchart of a method 400 for resource allocation in the contact center 100, according to another embodiment of the present invention.

At step 402, the predictive system 224 monitors parameters associated with the communication session and resources of the contact center 100, according to an embodiment of the present invention. In an embodiment of the present invention, the predictive system 224 monitors a type of the communication session such as, but not restricted to, a voice session, a video session, a Short Message Service (SMS), a web chat, an Instant Messaging (IM), an email communication, an Interactive Voice Response (IVR) session, a Voice over Internet Protocol (VoIP) session, and so forth. Further, the predictive system 224 monitors static details of the communication session by monitoring inputs selected by the customer in an IVR menu of the contact center 100, according to an embodiment of the present invention. The predictive system 224 further monitors details of the customer associated with the communication session, which may include, but not restricted to, personal information (for example, a name, a social networking username, etc.), contact information (for example, a telephone number, an email address, etc.), educational background, business contacts, education and work histories, likes, hobbies, favorite sport teams, frequency of conversations with a resource, a history of queries, a customer identification, communication history with the contact center 100, and so forth. Furthermore, the predictive system 224 monitors a type of the customer, according to an embodiment of the present invention. In an exemplary scenario, a customer may be, but not restricted to, a high priority customer, a medium priority customer, and/or a low priority customer.

Further, the predictive system 224 monitors details of resources of the contact center 100, according to an embodiment of the present invention. The details of a resource may include, but not restricted to, a name, a phone number, an extension number, resource identification (ID), social networking usernames, a resource's interests, hobbies, hometowns, favorite sport teams and TV shows, cultural background, education and work histories, skill set, technical training or experience in supporting a particular industry, company, or contact, and so forth.

The predictive system 224 further determines context of the communication session, according to an embodiment of the present invention. The context of the communication session may include, but not restricted to, a product inquiry support, a sales support, a health, or car policy support, a financial transaction support, and so forth. In an embodiment of the present invention, each of the performance indicators may be associated with a data value. Furthermore, the predictive system 224 extracts keywords from the monitored communication session, according to an embodiment of the present invention. In an embodiment of the present invention, the predictive system 224 monitors the parameters in a real-time environment.

At step 404, the predictive system 224 generated a performance score for each of the plurality of resources, according to an embodiment of the present invention. In an embodiment of the present invention, the predictive system 224 generates the performance score for each of the plurality of resources based on the monitored parameters and performance indicators stored in the database 228, according to an embodiment of the present invention.

In an embodiment of the present invention, the generated performance score may be a weighted combination of the data values associated with the performance indicators and the parameters. Further, the predictive system 224 ranks the resources based on their generated performance score, according to an embodiment of the present invention. In an embodiment of the present invention, the predictive system 224 ranks the plurality of resources based Key Performance Indicators (KPIs) of the contact center 100. The KPIs may include, but are not restricted to, revenue, estimated, actual, or predicted wait time, average speed of answer, throughput, resource utilization, resource performance, resource responsiveness and the like.

Further, at step 406, the predictive system 224 selects a resource from the plurality of resources to provide assistance and/or services to the customer of the communication session, according to an embodiment of the present invention. The predictive system 224 selects a resource based on the ranks of the plurality of resources, according to an embodiment of the present invention. In an exemplary scenario, for an incoming communication session from a potential customer, then a trainee may handle the communication session then a resource having ‘rank 7’ may be selected. In another exemplary scenario, it may be determined that a trainee of a contact center 100 may handle an outbound communication session of a medium priority customer, then a trainee having ‘rank 10’ may be selected. The predictive system 224 selects a resource based on the KPIs of the contact center 100, according to another embodiment of the present invention.

Thereafter, at step 408, the predictive system 224 routes the communication session to the selected resource of the contact center 100, according to an embodiment of the present invention. In an embodiment of the present invention, a supervisor of the contact center 100 may manually route the communication session to the selected resource. The predictive system 224 routes automatically route the communication session to the selected resource of the contact center 100, in accordance with another embodiment of the present invention. Next, at step 310, the predictive system 224 may store the performance score of the selected resource in a database such as the database 228 or the database 114, according to an embodiment of the present invention.

Next, at the step 410, the predictive system 224 validates the performance score of the selected resource based on handling of the communication session by the selected resource, according to an embodiment of the present invention. The predictive system 224 validates the performance score by calculating actual data values of the performance indicators, for example, preparation time, execution time, post-call time, or a combination thereof, after completing the communication session, according to an embodiment of the present invention. Further, the predictive system 224 combines the data values of the performance indicators to compute an aggregated performance score for the selected resource, according to an embodiment of the present invention. The predictive system 224 then compares the performance score and the aggregated performance score, which is then used to determine whether the resource have completed the communication session within the anticipated time, according to an embodiment of the present invention.

Further, the predictive system 224 may determine whether to another communication session is received, according to an embodiment of the present invention. If it is determined that another communication session is received, then the method 400 returns to the step 402. Otherwise, the method 400 terminates.

The exemplary embodiments of this present invention have been described in relation to a contact center. However, to avoid unnecessarily obscuring the present invention, the preceding description omits a number of known structures and devices. This omission is not to be construed as a limitation of the scope of the present invention. Specific details are set forth by use of the embodiments to provide an understanding of the present invention. It should however be appreciated that the present invention may be practiced in a variety of ways beyond the specific embodiments set forth herein.

Furthermore, while the exemplary embodiments of the present invention illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a switch, server, and/or adjunct, or collocated on a particular node of a distributed network, such as an analog and/or digital telecommunications network, a packet-switch network, or a circuit-switched network.

It will be appreciated from the preceding description, and for reasons of computation efficiency, the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, changes, additions, and omissions to this sequence can occur without materially affecting the operation of embodiments of the present invention.

A number of variations and modifications of the present invention can be used. It would be possible to provide for some features of the present invention without providing others.

For example in one alternative embodiment of the present invention, the systems and methods of this present invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like.

In general, any device(s) or means capable of implementing the methodology illustrated herein can be used to implement the various aspects of this present invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, non-volatile storage, input devices, and output devices. Furthermore, alternative software implementations including, but not limited to, distributed processing or component/object distributed processing, parallel processing, or virtual machine processing can also be constructed to implement the methods described herein.

In yet another embodiment of the present invention, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with embodiments of the present invention is dependent on the speed and/or efficiency requirements of the system, the particular function, and the particular software or hardware systems or microprocessor or microcomputer systems being utilized.

In yet another embodiment of the present invention, the disclosed methods may be partially implemented in software that can be stored on a storage medium, executed on programmed general-purpose computer with the cooperation of a controller and memory, a special purpose computer, a microprocessor, or the like. In these instances, the systems and methods of this present invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, it is not limited to such standards and protocols. Other similar standards and protocols not mentioned herein are in existence and considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the present invention has been presented for purposes of illustration and description. It is not intended to limit the present invention to the form or forms disclosed herein. In the foregoing Detailed Description, for example, various features of the present invention are grouped together in one or more embodiments, configurations, or aspects for the purpose of streamlining the disclosure. The features of the embodiments, configurations, or aspects may be combined in alternate embodiments, configurations, or aspects other than those discussed above. This method of disclosure is not to be interpreted as reflecting an intention the present invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A predictive system for resource allocation in an enterprise, the system comprising:
a database comprising one or more performance indicators for a plurality of resources, wherein the one or more performance indicators are associated with one or more work stages related to at least one communication session in the enterprise;
a monitoring module to monitor one or more parameters associated with the at least one communication session;
a determination module to generate at least one performance score for each of the plurality of resources based on the one or more parameters and the one or more performance indicators;
a selection module to select at least one resource from the plurality of resources based on the at least one generated performance score associated with the at least one selected resource.

2. The system of claim 1, wherein the determination module further determines at least one data value associated with each of the one or more performance indicators.

3. The system of claim 1, wherein the at least one generated performance score is a weighted combination of the at least one determined data value associated with each of the one or more performance indicators.

4. The system of claim 1, wherein the determination module further ranks the plurality of available resources.

5. The system of claim 4, wherein the plurality of available resources are ranked based on the at least one generated performance score.

6. The system of claim 4, wherein the plurality of available resources are ranked based on at least one key performance indicator.

7. The system of claim 1, wherein the selection module further routes the at least one communication session to the at least one selected resource.

8. The system of claim 1, further comprising a validation module to validate the at least one generated performance score associated with the at least one selected resource.

9. The system of claim 1, wherein the validation module further updates the at least one generated performance score in the database.

10. A computer-implemented method for resource allocation in an enterprise, the method comprising:
storing one or more performance indicators for a plurality of resources in at least one database, wherein the one or more performance indicators are associated with one or more work stages related to at least one communication session in the enterprise;
monitoring one or more parameters associated with the at least one communication session;
generating at least one performance score for each of the plurality of resources based on the one or more parameters and the one or more performance indicators;
selecting at least one resource from the plurality of resources based on the at least one generated performance score associated with the at least one selected resource;
routing the at least one communication session to the at least one selected resource; and
updating the at least one generated performance score of the selected resource in the at least one database.

11. The method of claim 10, further comprising generating at least one data value associated with each of the one or more performance indicators.

12. The method of claim 10, wherein the at least one generated performance score is a weighted combination of the at least one determined data value associated with each of the one or more performance indicators.

13. The method of claim 10, further comprising ranking the plurality of resources.

14. The method of claim 13, wherein the plurality of resources are ranked based on the at least one generated performance score.

15. The method of claim 13, wherein the plurality of available resources are ranked based on at least one key performance indicator.

16. The method of claim 10, further comprising validating the at least one generated performance score of the at least one selected resource.

17. A computer-implemented method to manage at least one communication session in an enterprise, the method comprising:
storing one or more performance indicators for a plurality of resources in at least one database, wherein the one or more performance indicators are associated with one or more work stages related to at least one communication session in the enterprise;
monitoring one or more parameters associated with at least one communication session;
generating at least one performance score for each of the plurality of resources based on the one or more monitored parameters and the one or more performance indicators;
selecting at least one resource from the plurality of resources based on the at least one generated performance score associated with the at least one selected resource;
validating the at least one generated performance score associated with the at least one selected resource based on handling of the at least one communication session by the at least one selected resource; and
updating the at least one validated performance score in the at least one database, wherein the at least one database is updated based on the validation of the at least one performance score.

18. The method of claim 17, further comprising routing the at least one communication session to the at least one selected resource.

19. The method of claim 17, further comprising ranking the plurality of resources based on the at least one generated performance score.

20. The method of claim 19, wherein the plurality of available resources are ranked based on at least one key performance indicator.
